(19) United States
(12) Patent Application Publication
(10) Pub. No.: US 2008/0029448 A1
(43) Pub. Date: Feb. 7, 2008

(54) Sealed magnet trap arrangement

(75) Inventors: Richard L. Duncum, Lakeside Marblehead, OH (US); Thomas M. Netsch, Louisville, KY (US); Albert L. O'Bryant, Louisville, KY (US); Brian W. Pahl, Louisville, KY (US); Mark A. Schroder, Memphis, TN (US)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel Advanced Filtration Concepts, Inc., Louisville, KY (US)

(21) Appl. No.: 11/580,074

(22) Filed: Oct. 13, 2006

Related U.S. Application Data
(63) Continuation of application No. 11/354,172, filed on Feb. 15, 2006, now abandoned.
Application No. 11/354,172 is a continuation of application No. 11/155,763, filed on Jun. 20, 2005, now abandoned.
Application No. 11/155,763 is a continuation of application No. 10/961,392, filed on Oct. 12, 2004, now abandoned.
Application No. 10/961,392 is a continuation of application No. 10/717,933, filed on Nov. 21, 2003, now abandoned.
Application No. 10/717,933 is a continuation of application No. 10/380,275, now abandoned.
(60) Provisional application No. 60/232,854, filed on Sep. 15, 2000.

(51) Int. Cl. B01D 35/06

(52) U.S. Cl. 210/197

(57) ABSTRACT

A liquid collection system for liquid coolant from a series of a plurality of machine tools with magnets for arresting and holding magnetic objects, such as broken bits from the milling machines or inadvertently dropped hand tools, entrained in the liquid coolant before they can damage liquid coolant recirculation pumps, with adjustable supports for adjusting the height of a coolant liquid collecting trough, and with a system of seals for sealing the collecting trough to support rails for the machine tools.

### BACKGROUND OF THE INVENTION

The present invention relates to a liquid collecting apparatus for a plurality of machine tools (i.e., metal cutting and/or milling machines) and more particularly to a recovery arrangement including a magnetic trap for recovering metallic materials such as metallic tools which might have inadvertently dropped into one or more of the liquid treating structures for one or more of the machine tools.

It has long been known in the metal arts to remove magnetizable particles such as ferrous metals from liquid streams with a magnetized structure, either of a permanent magnetic nature or electromagnetic in nature. For the most part, such past arrangements have included rotatable particle collector drums, each carrying the magnetized member so as to pass through a liquid from which the magnetizable particles are to be collected. Examples of such prior art rotatable drum type arrangements include the devices described in Scrivener, U.S. Pat. No. 2,459,343; Caldwell, U.S. Pat. No. 2,541,202; Vogel, U.S. Pat. No. 2,564,615; Blind, U.S. Pat. No. 2,597,561; Anderson, U.S. Pat. No. 2,717,080; Pierson, U.S. Pat. No. 3,087,616; Fritz, U.S. Pat. No. 3,552,565; Hengeli, U.S. Pat. No. 3,838,044; Schloemann, U.S. Pat. No. 4,046,679; and Fogle et al., U.S. Pat. No. 4,051,023. These prior art patents disclose relatively complex magnetizable drum structure arrangements which are comparatively difficult and costly to construct, operate and maintain and which are not readily installable in machine tool operations. Further, these prior art devices do not recognize, suggest or contemplate, let alone resolve the problems which might occur in multiple milling station operations due to improper tool usage, breakage or slippage or inadvertent loss of metal hand tools such as screwdrivers, wrenches and the like, nor do such prior art structures provide for efficient and ready removal of the consequences of such problems, allowing a prompt return to normal machine operations.

### SUMMARY OF THE INVENTION

The present invention recognizing that magnetic objects such as tools are not infrequently inadvertently introduced into a recirculated coolant liquid which usually accompanies one or more metal cutting station operations, provides a unique and novel structure and a unique and novel method which includes comparatively few parts and comparatively few operating steps, respectively. The present invention provides an arrangement which inherently helps resolve a reccurring problem in the machine tool or metal cutting machine art and which helps to minimize the subsequently concomitant damaging consequences of such problem. Specifically, the present invention provides a comparatively economic and straightforward structure and method which requires a minimum of parts and a minimum of steps to help capture magnetic objects such as magnetically responsive tools which have been inadvertently dropped into a system before such tools enter into downstream pumping systems so as to damage the same.

Various other features of the present invention will become apparent to persons skilled in the art from the following further description.

More particularly, the present invention provides a unique and novel recovery arrangement for recovering metallic materials, such as broken cutters or bits, or inadvertently dropped tools, such as screwdrivers or wrenches, from the liquid coolant collecting and recycling system before such metal materials or tools can become caught in the coolant collecting sump and possibly damage the recirculation pump. The inventive arrangement comprises a liquid discharge defining a first plenum, communicably adjacent a fluid source, to receive fluid therefrom, and a collecting trough defining a second plenum, at least a portion of which is of magnetically insulative material, the collecting trough is moveable upwardly and downwardly toward and away from the liquid discharge of a machine tool, i.e., toward and away from one or more support rails for a plurality of machine tools served by the collecting duct; sealing means between the collecting trough and the support rail to seal the trough to the support rail; adjusting means to raise and lower the trough to such sealed position; and magnetic means associated with the magnetically insulative portion of the collecting trough to arrest magnetically responsive materials entrained in liquid moving through the trough to facilitate recovery of such materials before they can reach the collection sump and possibly damage the pump.

In addition, the present invention provides a unique and novel method of recovering metallic materials including inadvertently dropped metallic tools which fall into a liquid collecting system comprising the steps of passing a coolant liquid from a machine tool to a collecting trough, conveying the liquid through the collecting trough past a non-magnetic section having a magnetic means adjacent the bottom of the trough which exert a magnetic flux through the trough sufficient to arrest and hold any magnetic objects entrained in the liquid, to a collecting sump provided with a pump for recirculating the liquid, thereby providing a restraining area to capture inadvertently dropped magnetizable materials including tools entrained in the collected liquid for recovery. In a preferred embodiment the collecting trough is moveable upwardly to seal the edges of the trough against support rails of the machine tools.

It is to be understood that various changes can be made by one skilled in the art in one or more of the several parts and several steps of the novel arrangement of the present invention without departing from the scope or spirit of the invention. For example, it would be possible to employ either permanent or electromagnetic restraining members or to even utilize other physical barriers to restrain inadvertently dropped tools or other magnetizable materials for recovery of the same before such materials can cause subsequent damage.

### BRIEF DESCRIPTION OF THE DRAWINGS

The invention will be described in further detail hereinafter with reference to illustrative preferred embodiments shown in the accompanying drawings in which:

FIG. 1 is a horizontal schematic side view of liquid collecting system according to the invention for collecting coolant liquid from a plurality of milling machines;

FIG. 2 is, an enlarged, side view of a preferred magnetic bar support arrangement fastened to the bottom of a non-magnetic section of a vertically adjustable trough according to the invention;

FIG. 3 is a bottom view of the trough and magnet arrangement of FIG. 2 showing a plurality of spaced magnetic bars attached to the bottom of the non-magnetic section of the trough;

FIG. 4 is an enlarged schematic cross-sectional view taken along line 4-4 of FIG. 1, showing the trough of the invention sealed to the underside of support rails for the machine tools;

FIG. 5 is an enlarged schematic cross-sectional view taken along line 5-5 of FIG. 1 showing the trough and magnet assembly of the invention, together with the trough seal;

FIGS. 6A and 6B are enlarged partial sectional views showing one embodiment of the novel trough seal in open and sealed relation, respectively;

FIGS. 7A and 7B, are enlarged partial sectional views similar to FIGS. 6A and 6B, showing another novel trough seal in open and sealed relation, respectively;

FIGS. 8A and 8B are bottom views of a portion of the trough disclosing two inventive fastening structures for removably attaching spaced permanent magnetic bars to the magnetically non-conducting bottom portion of a trough; and

FIG. 9 is a schematic illustration of an electromagnet arrangement which can be employed in the present invention as an alternative.

### DETAILED DESCRIPTION OF PREFERRED EMBODIMENTS

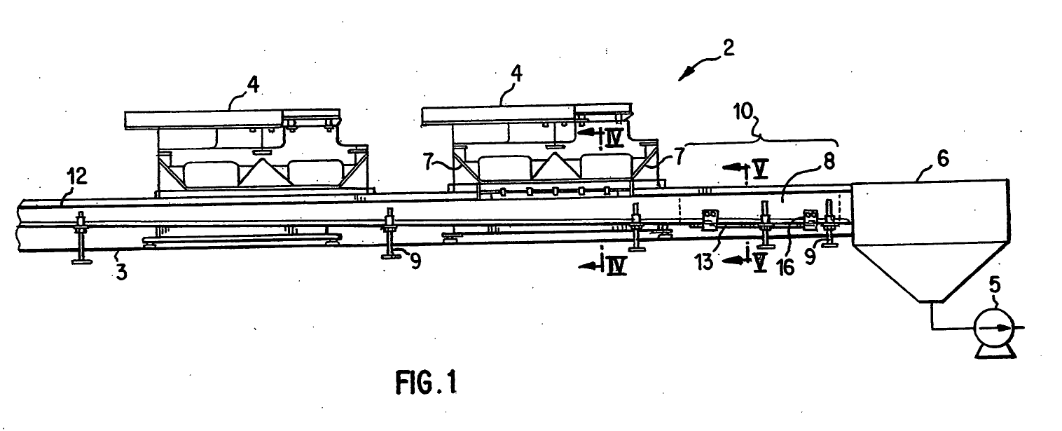

FIG. 1 shows a liquid collecting system, generally designated by reference numeral 2, which serves a series spaced working stations, such as machine tool stations, at which magnetically responsive metal tools are employed. The figure shows two spaced ground level milling machines 4 installed on a floor 3. The machine tools 4 are associated with a gravity inclined fluid trough 8 which terminates at a cone bottom sump tank 6 from which the coolant liquid can be recycled or disposed of in a suitable manner, by means of a pumping arrangement 5. A portion of one of the metal cutting machines is broken away to reveal two liquid discharge ducts 7. Liquid discharges 7 discharge used coolant liquid to a recirculating apparatus as a part thereof, the recirculating apparatus including filter devices to recondition the coolant for reuse by filtering out particles before the liquid is recirculated to the milling machines 4. The liquid discharges 7 serve as an initial part of a coolant liquid recirculation arrangement.

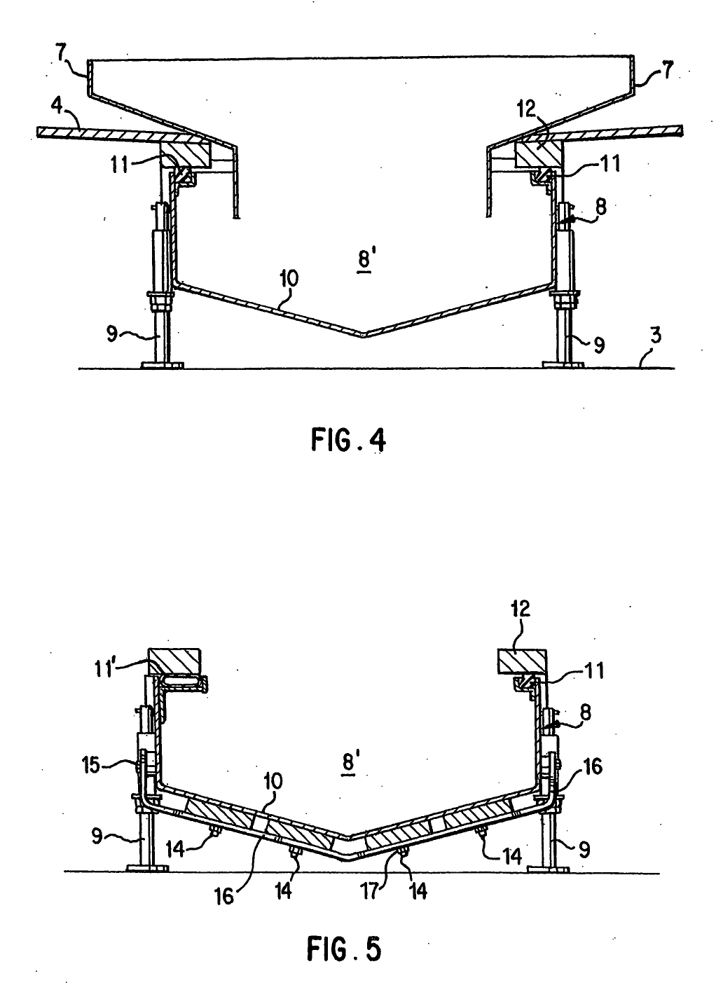

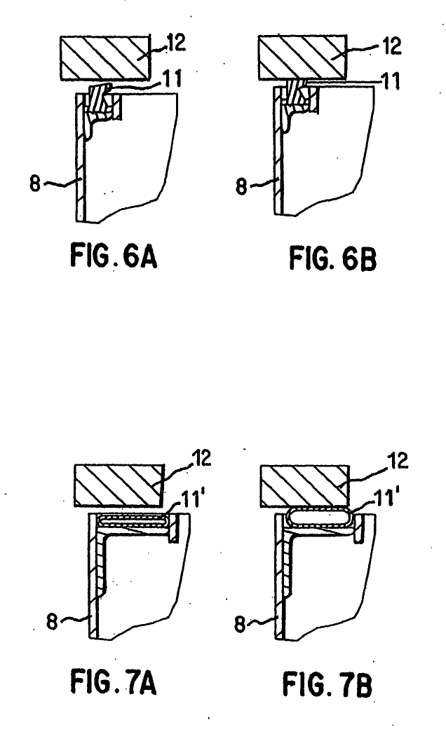

The liquid discharges 7 and the lower communicably aligned trough 8, described hereinafter and shown in FIGS. 4 and 6, each have spaced opposed side walls to define communicably connected upper and lower communicably connectable fluid receiving plenums 7′ and 8′, respectively. The trough 8 is vertically moveable with respect to the machine tools 4. As illustrated in FIGS. 3 and 4 of the drawings, the trough 8 can be moved upwardly to engage in sealed relation with the sides of upper troughs 8. This elevational movement can be accomplished through a plurality of spaced, threaded male-female screw-jack standards 9 connected to lower trough 8. These screwjack standards can be adjusted to elevate the lower moveable trough 8 upwardly into sealing engagement with support rails 12 which connect the machine tools 4. It is to be understood that other mechanisms can be utilized to move the trough 8 into sealing relationship with the rails 12.

As can be seen in FIGS. 4, 6A and 6B, a longitudinally extending surrounding flexible sealing strip 11 is provided along the upper edges of trough 8. Strip 11 can be made of a suitably resilient, compressible-expansible filled material, such as a buna rubber, which can be compressively utilized to seal the trough 8 against support rail 12. As can be seen in FIGS. 6A and 6B, the cross-section of surrounding flexible strip 11 can be configured to provide initial longitudinal tip-to-flat compressed sealing engagement with the bottom of milling machine support rail 12.

As can be seen in the embodiment depicted in FIGS. 5, 7A and 7B, the seal can alternatively be made of a surrounding, longitudinally extending, suitable hollow flexible-expansible tubing 11′, which can be inflated or deflated by introduction of an appropriate fluid, either gas or liquid.

In accordance with another feature of the present invention, collecting trough 8 is arranged to incline downwardly toward a collecting sump 6, so that coolant liquid received from discharges 7 can flow by gravity to the sump 6. The trough is vertically movable by means of adjustable jacks 9 to press seals 11, 11′ at the upper edges of the trough against support rails 12 for the milling machines 4 to prevent leakage therebetween. It is to be understood that once spaced standards 9 have moved trough 8 into sealed position, appropriate locking nuts can be attached to secure jacks 9 or the standards can be appropriately welded in fixed position.

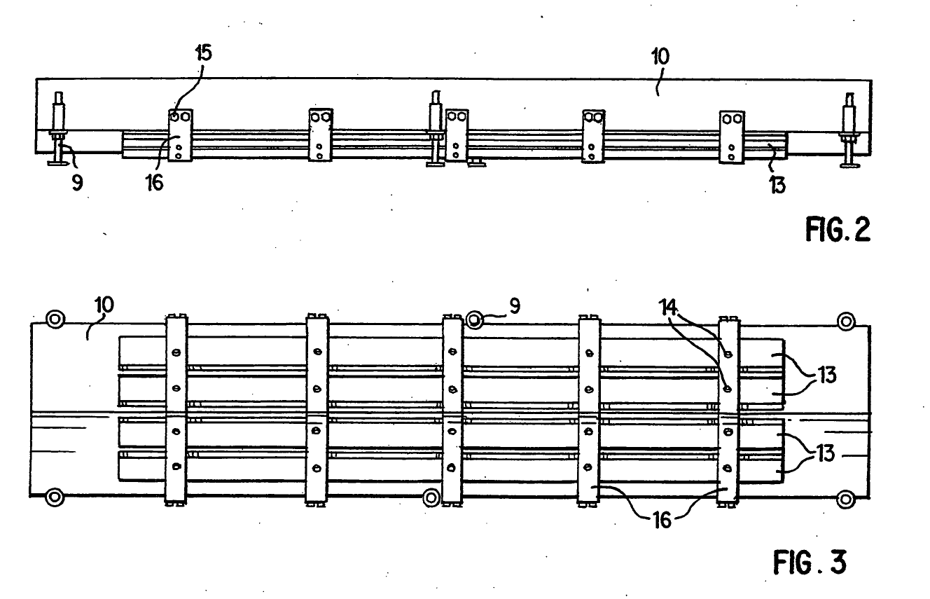

As can be seen in FIGS. 1-5 and FIGS. 8A and 8B of the drawings and in accordance with another feature of the present invention, a non-magnetic section 10 of trough 8, is formed from a magnetically resisting, magnetically permeable material such as stainless steel. As shown in FIGS. 4 and 5, the upper edges of trough 8 sealingly engage support rails 12 for the milling machines 4.

In order to remove metallic materials such as metallic tool members inadvertently dropped into the liquid collecting system, a plurality of spaced longitudinally extending bar magnets 13, which may be permanent magnets or electromagnets and which may be of reversible polarity, are appropriately sized to extend along and adjacent to the bottom face of the non-magnetic section 10 of trough 8 interposed between fluid discharges 7 and collecting sump 6. Magnets 13 provide a magnetic flux density adjacent the opposing face of the bottom portion of trough 8 in the range of approximately sixteen hundred (1600) to twenty four hundred (2400) gauss. Particularly advantageous results may be obtained with a flux of about two thousand (2000) gauss. A flux of this density sufficient to arrest and hold any magnetic objects such as broken bits from the milling machine or inadvertently dropped tools which reach trough 8 with the coolant liquid.

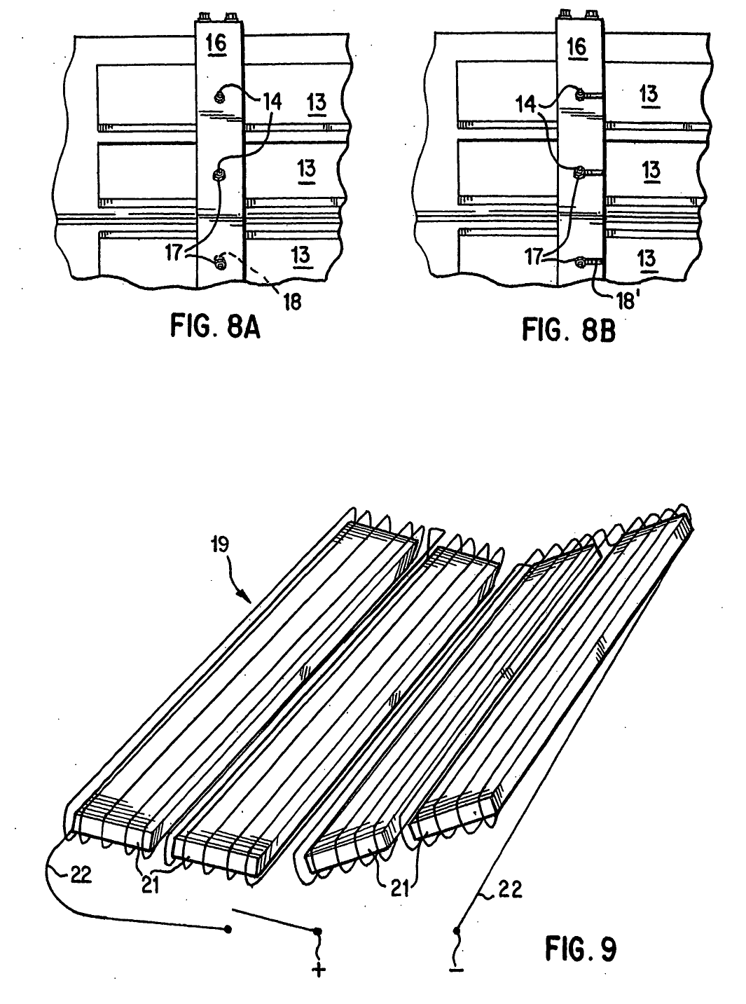

Magnetically insulative, magnetically permeable, spaced support straps 16 are provided to support magnets 13 adjacent the bottom of trough 8. As seen most clearly in FIGS. 5, 8A and 8B, each magnet is provided with spaced studs 14 extending from the bottom face thereof The distal ends of studs 14 are so spaced to engage in aligned, spaced sized apertures 18 in straps 16. The opposed ends of each strap 16, in turn, are attached to the sidewall faces of trough 8 by mounting bolts 15. Referring to FIG. 8A, it can be seen that the spaced apertures 18 in straps 16 can be positioned intermediate the opposed side edges of the straps. Alternatively, the apertures can be in the form of slots 18′ extending normal to the longitudinal axis of and opening out one side edge of each strap 16 (FIG. 8B). The slots 18′ facilitate ready removal of magnets 13 by simply sliding studs 14 out through the open ends of the slots. It is to be noted that the strap engaging distal ends of studs 14 can be appropriately externally threaded to engagingly receive an internally threaded nut 17 to hold the magnets in place.

Once an inadvertently dropped tool or other magnetic object is captured, the magnetic object can be recovered and removed from the trough. If desired, the magnets 13 may be removed to assist in releasing the magnetic object from trough 8.

Although the above specification, is addressed to metal cutting stations, it is to be understood that the present invention can be employed in other working environments where magnetic objects need to be recovered from a liquid. It further is to be understood that the spaced magnetic bars 13, which are shown as being parallel to the line of fluid flow, can also be arranged perpendicular to the line of fluid flow.

If desired, the permanent magnet bars 13, as described above, could be replaced with electromagnets. An example of a possible electromagnet arrangement is shown in FIG. 9. This figure schematically illustrates an electromagnet arrangement 19 including a core 21 of soft iron and an electrically chargeable coil 22 wrapped around the core 21.

In accordance with still another feature of the invention, a novel method is provided of readily recovering magnetic objects, including inadvertently dropped metallic tools, from a liquid. The method of the invention includes the steps of passing used coolant liquid from a machine tool discharge to a collecting trough leading to a collecting sump, the trough having at least a non-magnetic section, and providing a restraining area in the non-magnetic section to capture magnetic objects, such as inadvertently dropped magnetic tools and parts, entrained in the liquid. The restraining area preferably exerts a metallic tool restraining magnetic flux density in the range of sixteen hundred (1600) to twenty-four hundred (2400) gauss, which is sufficient to arrest and hold any magnetic object entrained in the liquid in the trough. Preferably, the magnetic flux is about two thousand (2000) gauss. The magnets may be permanent magnets or they may be electromagnets.

The foregoing description has been set forth merely to illustrate the invention and is not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A liquid collecting system for machine tool coolant comprising an elongated trough in fluid communication with coolant liquid discharges of a plurality of machine tools to receive coolant liquid therefrom; said trough sloping downwardly toward a collecting sump provided with a pump for recirculating collected coolant liquid; said trough comprising at least a non-magnetic section interposed between said fluid discharges and said collecting sump, and a plurality of magnets mounted adjacent the underside of said non-magnetic section of said trough; said magnets exerting a magnetic flux through said trough sufficient to arrest and hold magnetic objects entrained in the coolant liquid, whereby said magnetic objects are prevented from reaching said collecting sump and said pump.

2. A liquid collecting system according to claim 1, wherein said magnets are mounted on a plurality of support straps extending underneath the trough and secured to opposite sides thereof.

3. A liquid collecting system according to claim 2, wherein said magnets are provided with studs which are received in openings in said support straps.

4. A liquid collecting system according to claim 3, wherein said studs are provided with screw threads at distal ends thereof for receiving fastening nuts to secure the magnets to the support straps.

5. A liquid collecting system according to claim 3, wherein said openings are open ended slots, whereby said magnets can be removed from the support straps by sliding the studs out of the slots.

6. A liquid collecting system according to claim 1, wherein said magnets comprise elongated bars of magnetic material extending parallel to the longitudinal direction of said trough.

7. A liquid collecting system according to claim 1, wherein said magnets are permanent bar magnets.

8. A liquid collecting system according to claim 1, wherein said magnets are electromagnets.

9. A liquid collecting system according to claim 1, wherein said non-magnetic section of said trough is made of stainless steel.

10. A liquid collecting system according to claim 1, wherein said trough is mounted on vertically adjustable support members, whereby the height of the trough can be adjusted.

11. A liquid collecting system according to claim 10, wherein said vertically adjustable support members comprise screw jacks.

12. A liquid collecting system according to claim 1, wherein said magnets exert a magnetic flux of from 1600 to 2400 gauss through said trough.

13. A liquid collecting system according to claim 12, wherein said magnets exert a magnetic flux of about 2000 gauss through said trough.

14. A liquid collecting system according to claim 1, wherein said plurality of machine tools are connected by at least one support rail, and said trough is provided at least one seal element at an upper edge thereof for sealing said trough against said at least one support rail.

15. A liquid collecting system according to claim 14, wherein each said seal element comprises a resilient strip extending along an upper longitudinal edge of said trough, said resilient strip having an edge which engages is the underside of a respective support rail in sealing contact therewith.

16. A liquid collecting system according to claim 14, wherein each said seal element comprises an inflatable tubular member which can be expanded into sealing contact with a respective support rail.

17. A liquid collecting system for machine tool coolant comprising an elongated trough in fluid communication with coolant liquid discharges of a plurality of machine tools to receive coolant liquid therefrom; said trough sloping downwardly toward a collecting sump provided with a pump for recirculating collected coolant liquid; wherein said plurality of machine tools are connected by at least one support rail, and said trough is provided at least one seal element at an upper edge thereof for sealing said trough against said at least one support rail.

18. A liquid collecting system according to claim 17, wherein said trough comprises a non-magnetic section interposed between said fluid discharges and said collecting sump, and magnet means mounted adjacent the underside of said non-magnetic section of said trough; said magnet means exerting a magnetic flux through said trough sufficient to arrest and hold magnetic objects entrained in the coolant liquid, whereby said magnetic objects are prevented from reaching said collecting sump and said pump.

19. A liquid collecting system according to claim 18, wherein said magnet means exerts a magnetic flux of from 1600 to 2400 gauss through said trough.

20. A liquid collecting system according to claim 18, wherein said magnet means exerts a magnetic flux of about 2000 gauss through said trough.

21. A liquid collecting system according to claim 17, wherein said trough is mounted on vertically adjustable support members, whereby the height of the trough can be adjusted to urge the seal elements against the underside of the support rail.

22. A liquid collecting system according to claim 21, wherein said vertically adjustable support members comprise screw jacks.

23. A liquid collecting system according to claim 17, wherein each said seal element comprises a resilient strip extending along an upper longitudinal edge of said trough, said resilient strip having an edge which engages is the underside of a respective support rail in sealing contact therewith.

24. A liquid collecting system according to claim 17, wherein each said seal element comprises an inflatable tubular member which can be expanded into sealing contact with a respective support rail.
